(19) United States
(12) Patent Application Publication
(10) Pub. No.: US 2018/0360254 A1
(43) Pub. Date: Dec. 20, 2018

(54) Device and Method for Automatic Pod Cooking with Temperature and Water Control

(71) Applicant: Kitchen Mate Inc., Mississauga (CA)

(72) Inventors: Anthony Marino, East York (CA); Lucas Demingeon, Toronto (CA); Weiqing Fang, North York (CA); Yang YU, Mississauga (CA)

(21) Appl. No.: 15/880,072

(22) Filed: Jan. 25, 2018

Related U.S. Application Data
(60) Provisional application No. 62/520,973, filed on Jun. 16, 2017.

(51) Int. Cl. A47J 27/04; A47J 27/00; A23L 5/10; B65D 81/34

(52) U.S. Cl. CPC A47J 27/04; A47J 27/004; A47J 2027/043; B65D 81/3438; A23L 5/13

(57) ABSTRACT

The present application provides a method and device for cooking a pre-packaged pod of uncooked food ingredients using a pre-programmed recipe associated with the pod, and determined by scanning a barcode or other indicia on the pod. Cooking variables, such as the temperature and water content in the pod for cooking the ingredients, are measured by the device, and heat and water amounts can be adjusted as required for the recipe based on a thermal function associated with the recipe. The device comprises one or more sensors for determining the temperature and humidity inside the pod, and the temperature and/or humidity are adjustable depending on the thermal function associated with the particular pod, by controlling the amount of heat and/or water added to the pod. Pods that may be used with the cooking device have an elevated base layer providing a reservoir of water, provided by a water dispensing means, for adding steam to the contents of the pod through one or more openings in the floor of the pod, which also allow the draining of fluids, such as undesired fluids, from the food being cooked.

### CROSS-REFERENCE TO RELATED APPLICATION

This application claims the benefit and priority of U.S. Provisional Application No. 62/520,973 filed Jun. 16, 2017 which is incorporated herein by reference in its entirety.

### FIELD

The present application pertains to the field of cooking. More particularly, the present application relates to a method and device for cooking meals contained in pods automatically using pre-programmed recipes by controlling heating and water/humidity.

### BACKGROUND

To cook a meal, most humans rely on traditional appliances, such as ovens, grills, stovetops or microwaves. This can be time consuming, expensive, and labour intensive to ensure a properly cooked meal is achieved and enjoyed, particularly if the user is seeking to prepare a more healthy meal using raw ingredients. This can be challenging, particularly for a novice cook, who may be unfamiliar with the process to cook a desired meal, such as how to follow a recipe or how to add ingredients and cooking/heating steps in an appropriate manner.

Pre-cooked and oven ready frozen meals are also available. These meals can be re-heated in an oven or microwave. However, there may be a compromise on quality of ingredients or with inconsistent cooking results.

Devices for cooking known in the art include those described in US2016/0367062A1, U.S. Pat. No. 7,473,869, U.S. Pat. No. 9,271,594, US 2016/0150915, and U.S. Pat. No. 6,516,709. Cooking methods using steam are provided in U.S. Pat. No. 8,302,527.

There is a need for a machine and method of cooking, whereby heating and humidity can be controlled to achieve high quality meals consistently using raw ingredients.

This background information is provided for the purpose of making known information believed by the applicant to be of possible relevance to the present invention. No admission is necessarily intended, nor should be construed, that any of the preceding information constitutes prior art against the present invention.

### SUMMARY

An object of the present invention is to provide a method and device for cooking meals contained in pods using pre-programmed recipes, and having a means to control temperature and water (humidity).

In accordance with one aspect, there is provided an automatic cooking device for cooking one or more pre-packaged ingredients in a cooking pod, the device comprising: a device body; a heating element for receiving and heating the cooking pod; a barcode reader for reading a barcode or other indicia on the cooking pod; one or more sensors for measuring one or more cooking variables in the cooking pod; a water dispensing means to dispense a quantity of water to the inside of the pod; and a computer processor.

Cooking variables include one or more of temperature, humidity, duration of cooking, and the like.

In certain embodiments, the one or more sensors measure the temperature and/or humidity on the inside of the pod, and the one or more sensors is/are in communication with the heating element and/or the water dispensing means, directly and/or via the computer processor. The barcode identifies a thermal function associated with cooking the ingredients in the pod. In one embodiment, the thermal function comprises a set of instructions for adjusting the one or more cooking variables associated with cooking the contents of the pod.

In one embodiment, the processor comprises computer readable memory comprising instructions for executing the thermal function. In one embodiment, the processor obtains instructions for executing the thermal function remotely, including from a remote database obtained through a network including Wifi.

In one embodiment, the one or more sensors determines a temperature inside the pod and adjusts the temperature of the pod as required by modulating the heating element.

In one embodiment, the water is stored in a reservoir on board the device body. In certain embodiments, the one or more sensors and/or the water dispensing means create an opening in a pod seal to permit water to enter the pod and/or to facilitate sensing of the temperature and/or humidity on the inside of the pod by the one or more sensors, and/or to release excessive steam or pressure from the pod.

In certain embodiments, the pod comprises one or more compartments comprising one or more ingredients therein. In one certain embodiments, the pod comprises an elevated base layer disposed between a floor of the pod in contact with the ingredients therein, and a bottom surface of the pod in contact with the heating element. In certain embodiments, the floor of the pod comprises one or more openings therethrough to provide communication between at least a portion of the interior of the pod and the elevated base layer. The openings may permit the passage of fluids from the interior of the pod through the openings and into the elevated base layer. In certain embodiments, the openings permit the passage of water and/or steam therethrough, such as the passage of steam from the elevated base layer to the interior of the pod.

In accordance with another aspect, there is provided a method of cooking a quantity of food pre-packaged in a cooking pod, the method comprising: a. introducing the pod into a cooking device having a barcode reader for reading a barcode or other indicia on a surface of the pod; b. determining a recipe corresponding to information obtained from reading the barcode; c. determining the temperature inside the pod and, if the temperature is different from the temperature required by the recipe, adjusting the temperature to a target temperature in accordance with a thermal function associated with the recipe, using a heating element in the cooking device; d. determining humidity inside the pod corresponding with the recipe and, if required, adding water to the pod; e. if necessary, repeating steps c. to d. to ensure a proper temperature and humidity are provided inside the pod in accordance with the recipe; f. heating the pod for a desired length of time at the target temperature until the contents of the pod are cooked in accordance with the recipe; g. removing the pod from the device at the termination of cooking, for consumption of the contents of the pod.

In certain embodiments, the pod is placed in contact with the heating element in the cooking device. During the step of determining the temperature of the pod, the heat may be adjusted to a target temperature based on the thermal function and, if necessary, a calibration variable further adjusts the temperature based on the contact efficiency between the pod and the heating element.

In certain embodiments, the step of determining the temperature and the step of determining the humidity inside the pod is determined by one or more sensors. In one embodiment, the one or more sensors are positioned on a surface of the lid of the cooking device which is in contact with the pod, such that when the lid is closed with the pod in the cooking device, the one or more sensors punctures an opening in a covering on the pod, thereby providing access of the sensor(s) to an interior of the pod. The one or more sensors are typically in communication with the heating element and/or a water dispensing reservoir directly or through a processor in the cooking device.

In certain embodiments, the step of adding water to the pod is performed by a water dispensing means. In one embodiment, the water dispensing means is positioned on a surface of the lid of the cooking device, wherein when the lid is closed, the water dispensing means punctures an opening in a covering on the pod, such that the water dispensing means has access to provide water to the interior of the pod. Typically, the water dispensing means is in fluid communication with a water dispensing reservoir.

In one embodiment, the step of determining the temperature and/or humidity is performed on a regular interval, such as every 1 second.

In certain embodiments, the pod comprises an elevated base layer disposed between a floor of the pod in contact with the ingredients therein, and a bottom surface of the pod in contact with the heating element. In certain embodiments, the floor of the pod comprises one or more openings therethrough to provide communication between at least a portion of the interior of the pod and the elevated base layer. Typically, the openings permit the passage of fluids from the ingredients through the openings in the floor and into the elevated base layer, such as permitting the passage of water and/or steam therethrough. In certain embodiments, in the step of adjusting the temperature, when the temperature is increased, the heating element is activated to increase the temperature inside the pod, thus forming a quantity of steam from at least a portion of any water in the elevated base layer, whereby the steam is permitted to pass through the openings from the elevated base layer to the interior of the pod.

The present application provides a method and device for cooking pre-prepared meals where the food to be cooked is pre-assembled in a pod. The meals contained in the pods can be cooked in the device automatically, based on a pre-programmed recipe for each pod that provides specific information (thermal function) for controlling the heat and humidity of the recipe during the cooking process. By providing better heating control and humidity control, a better taste and texture of the individual ingredients is achieved. Also, there is no need for a consumer to go and obtain ingredients for a particular recipe, as the ingredients are already provided in the pod. Further, the user does not need to search for and input a recipe, as the recipe is automatically associated with a given pod.

### BRIEF DESCRIPTION OF THE FIGURES

For a better understanding of the present invention, as well as other aspects and further features thereof, reference is made to the following description which is to be used in conjunction with the accompanying drawings, where:

FIGS. 1A and 1B provide, respectively, a top view and a bottom view of one embodiment of the device with the lid closed, as described herein.

FIGS. 2A and 2B provide, respectively, a front view (top) and a side view (bottom) of one embodiment of the device with the lid open, as described herein.

FIGS. 3A and 3B provide, respectively, a front view (top) and a side view (bottom) of a device with the lid open and containing an exemplary empty pod therein, as described herein.

FIG. 4 provides an exemplary empty cooking pod.

FIG. 5 provides an open side view of one embodiment of an exemplary device, showing an exemplary water reservoir, a water feed tube and a pod.

FIG. 6 provides a flowchart illustrating an exemplary pod identification and recipe program download method as described herein.

FIG. 7 provides a flowchart illustrating an exemplary pod cooking process as described herein.

FIG. 8 provides a flowchart illustrating an exemplary method of setting initial water and power as described herein.

FIG. 9 provides a flowchart illustrating an exemplary thermal automation process as described herein.

FIG. 10 provides an exemplary user interface for selecting recipes for using the method and devices as described herein.

FIGS. 11A-C illustrate three views of an exemplary pod having two compartments, which may be used in the context of the present application.

FIGS. 12A-C illustrate three views of an exemplary pod having one compartment, which may be used in the context of the present application.

FIGS. 13A and B illustrate two views an exemplary cooking device as described herein.

### DETAILED DESCRIPTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

The present application provides a device and method for cooking meals using a pre-packaged container of food ingredients, referred to herein as a “pod”. The pod may comprise any number of ingredients, but can be used as a vessel to prepare a meal based on pre-programmed instructions in a cooking device. A user inserts a pod into the device and the device automatically prepares the meal according to a selected recipe.

As used herein, a “recipe” may include a particular set of instructions to control the temperature and humidity in the pod during the cooking process. In certain embodiments, a recipe includes a “thermal function”. The thermal function is based on one or more controls, typically two or more controls including, for example, temperature and humidity, for the cooking process. The thermal function may be used to add, for example, heat and/or water to the pod during the cooking process.

The following describes various components of the present cooking device and method.

Pods

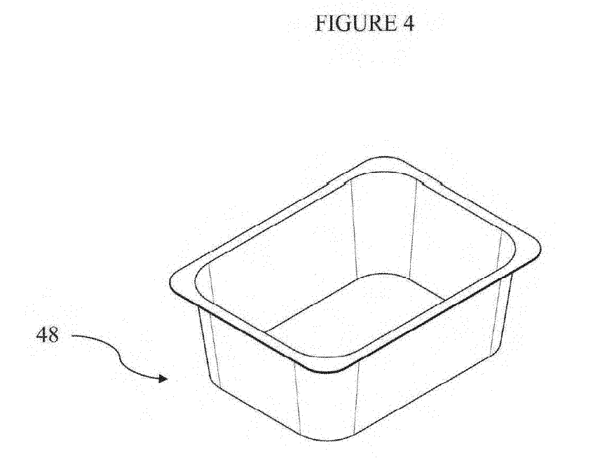

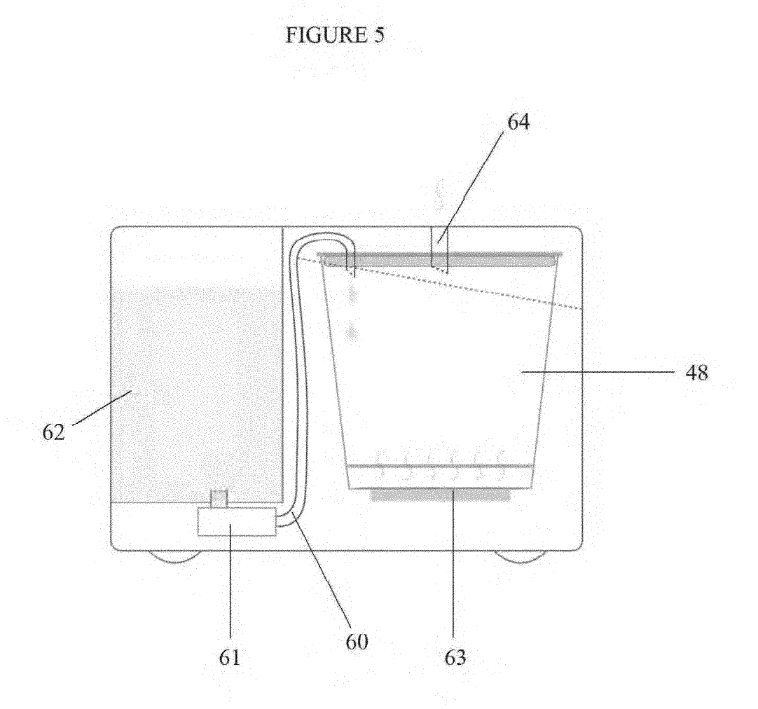

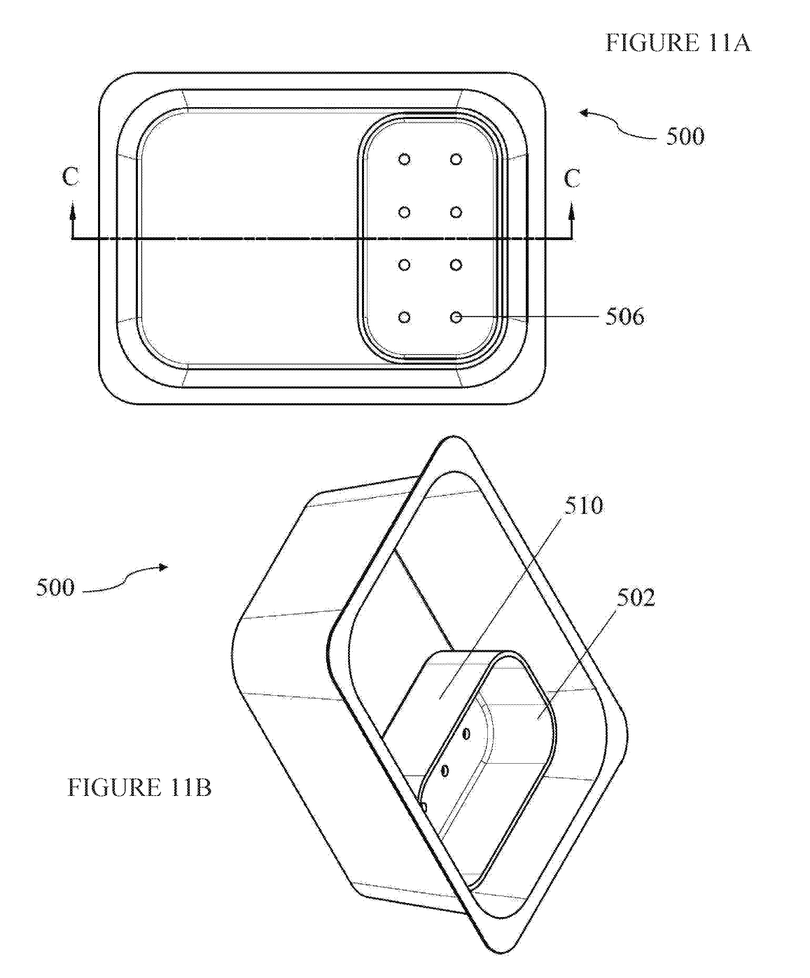

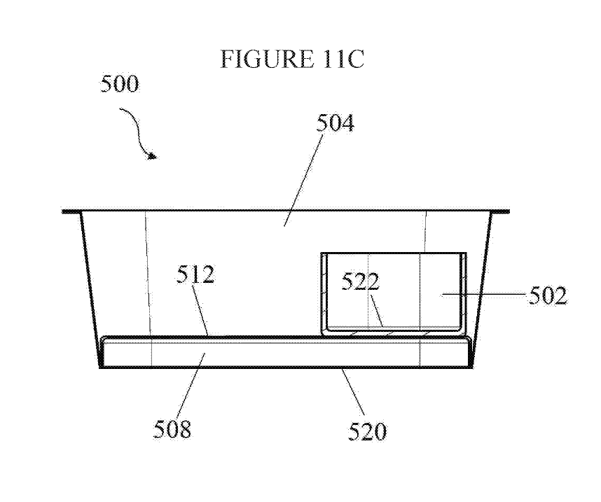

Exemplary pods which may be used in the context of the present application are illustrated in FIGS. 4, 11A-C and 12A-C. An exemplary pod that may be used in the context of the present application is any suitable container that can withstand heat for cooking, typically at a temperature no more than, for example, 160° C. Typically, a pod may be comprised of a durable material, such as aluminum, plastic, steel or the like. Ideally, the pod is relatively lightweight to facilitate transport and ease of use. Using lightweight yet durable materials can help reduce costs and create a smaller carbon footprint. However, the material should ideally be suitable to permit efficient and effective heat conductive transfer from the device to the ingredients in the pod for cooking the ingredients and making the meal in accordance with the desired recipe. The pod should ideally be sealed, typically on a top surface thereof, by a durable member (such as with a plastic or other durable non-toxic and inert substance). The durable member should be readily removable by the user for consuming the product inside the pod. Typically, the durable member should be resistant to the degree of heat required to heat the contents of the pod, such that the member does not become deformed or lose its integrity in keeping the pod sealed. However, the member should ideally be selectively deformable (e.g. pierceable) as required by the recipe, to permit entry of ingredients (including, for example, spices, steam or water, etc.) during or after the cooking process, and to monitor the temperature and/or humidity inside the pod. The pod may be of a material to allow perforations or other openings to be added, permitting the entry of liquids, food or other ingredients inside the pod, or the perforations can be used to provide a pressure release opening (such as for steam). Thus, the pod as a whole should be sealed from outside elements, but permitted to introduce ingredients as desired.

A pod can have any volume. Ideally, the volume of the pod is selected to correspond to a standard sized meal. Pods are typically designed to fit into a compartment of a cooking device, such as one described herein. In certain embodiments, a pod for use herein may be rectangular in shape; however, other shapes, such as round, oval or square may be contemplated.

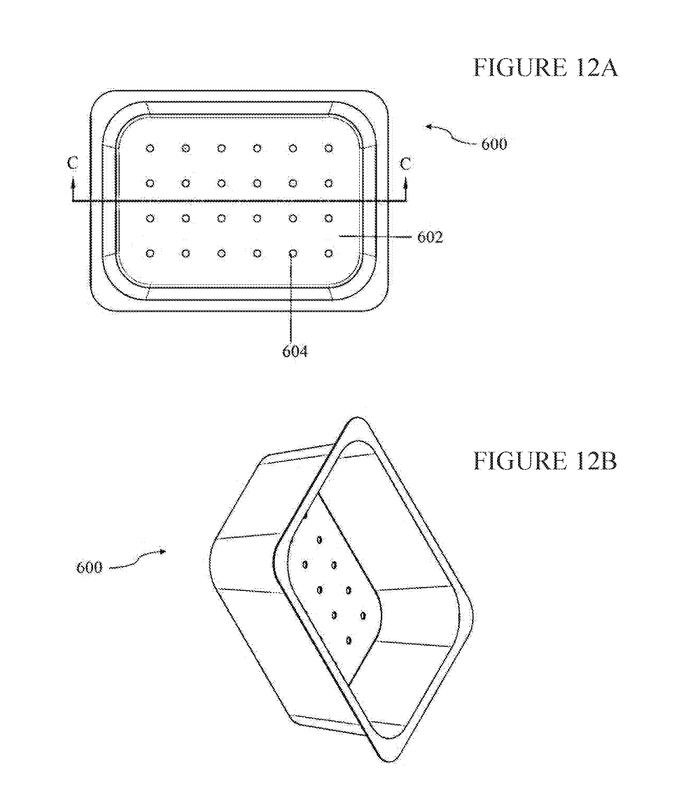

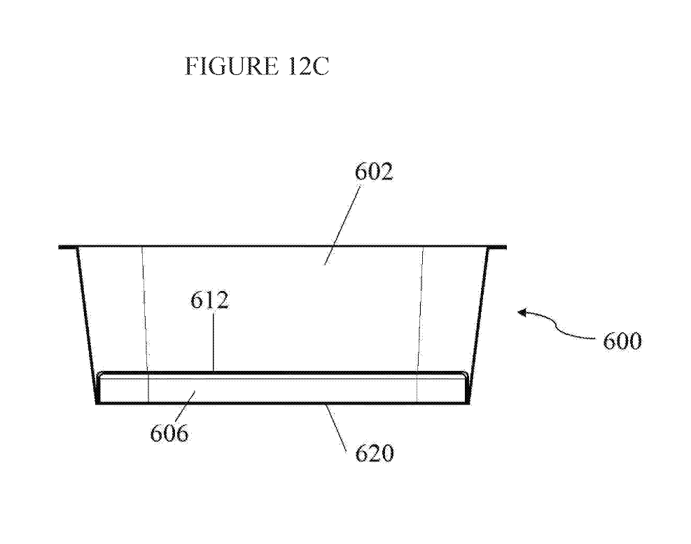

A pod can have one or more internal compartments for storing, for example, different ingredients of the meal to be cooked. FIGS. 11A-C illustrates an exemplary pod 500 having two compartments (502 and 504). FIG. 11A shows a top view of the pod; FIG. 11B shows an alternate view of the pod; and FIG. 11C shows a side view of the pod (cross section “C” in FIG. 11A). FIG. 12A-C illustrate an exemplary pod 600 having one compartment 602. FIG. 12A shows a top view of the pod; FIG. 12B shows an alternate view of the pod; and FIG. 12C shows a side view of the pod (cross section “C” in FIG. 12A). Each compartment may be of a particular size and shape, and occupy the same or different percentage of the volume of the pod. Each compartment may be separated by a barrier 510 which can either permit (i.e. partially or completely permeable, or selectively permeable) or prohibit (i.e. impermeable) the mixing of ingredients initially placed in each of the compartments, depending on the recipe and/or the desire of the user. For example, one compartment may contain a meat portion, one compartment may contain a vegetable portion, and another compartment may contain a sauce portion. The components of the pod are typically pre-assembled prior to purchase by the user. A user, therefore, would not need to worry about what ingredients are required for the desired recipe, since they would all be included in the pod. However, a user may modify the cooking process to adjust the cooking time, or add other ingredients (including sauces and spices) to taste, for example. In certain embodiments, a user may be able to adjust the doneness of the meal. Typically, though, this is not an alteration of the thermal function for the associated meal. Instead, the user may adjust the time of cooking, for example. The thermal function would ideally stay the same for the particular pod, but the doneness would be affected as a result of extended or shortened time. In some embodiments, there may also be a minimum doneness which typically provides the amount of temperature and cooking duration it takes to bring the ingredients in a particular pod into a safe-to-eat internal temperature.

As illustrated in FIGS. 11A-C and 12A-C, in one embodiment, a pod may comprise an elevated base layer (508 and 606, shown particularly in FIGS. 11C and 12C, respectively). The elevated base layer ideally provides a zone between a surface 512, 612 (“floor”) of the compartment (such as exemplary compartments 502, 504 and 602) of the pod that is in contact with the food to be cooked in the pod, and a bottom surface 520, 620 of the pod which is in contact with a heating surface (such as a conductive heating plate or heating element, for example). The elevated base layer 508, 606 may serve a number of functions. First, it provides a buffer between the floor 512, 612 of the pod 500, 600 and the heating surface, ideally preventing burning of the contents of the pod. Second, it can trap undesired liquids (such as fat, for example) that may drip from the food in the pod. Third, it provides a reservoir of water for steaming the food in the pod. The steaming action will be described in more detail below.

In certain embodiments, a pod may have one or more holes in the floor, which are in communication between one or more compartments in the pod and the elevated base layer. In the exemplary embodiment shown in FIG. 11A-C, holes (such as hole 506) are provided on the floor 522 of compartment 502, to be in communication with elevated base layer 508. In the exemplary embodiment shown in FIG. 12A-C, holes (such as hole 604) are provided on the floor 612 of compartment 602, to be in communication with elevated base layer 606. Ideally, the holes permit the passage of fluids, such as steam from water in the elevated base layer, or cooking juices from the food in the pod (including undesirable fluids, such as fats, for example). The hole or holes may be located beneath one or more compartments of the pod; thus, the holes permit fluids from those compartments to enter the elevated base layer, and/or permit steam to enter those compartments. The steam, for example, may also travel to other compartments in the pod, allowing the transfer of humidity (and associated heat) from some areas of the pod to other areas of the pod.

In typical embodiments, the pod has a barcode or other scannable indicia placed on or integrated therein, such as on the top surface of the sealing member, for example. The barcode ideally provides information pertinent to the contents of the pod, the recipe requirements, and/or any other special requirements. The information may be stored onboard the cooking device, or in a remote server location. In certain embodiments, the barcode provides information related to the thermal function (e.g. temperature and/or humidity) for cooking the particular contents of the specific pod.

Cooking Device

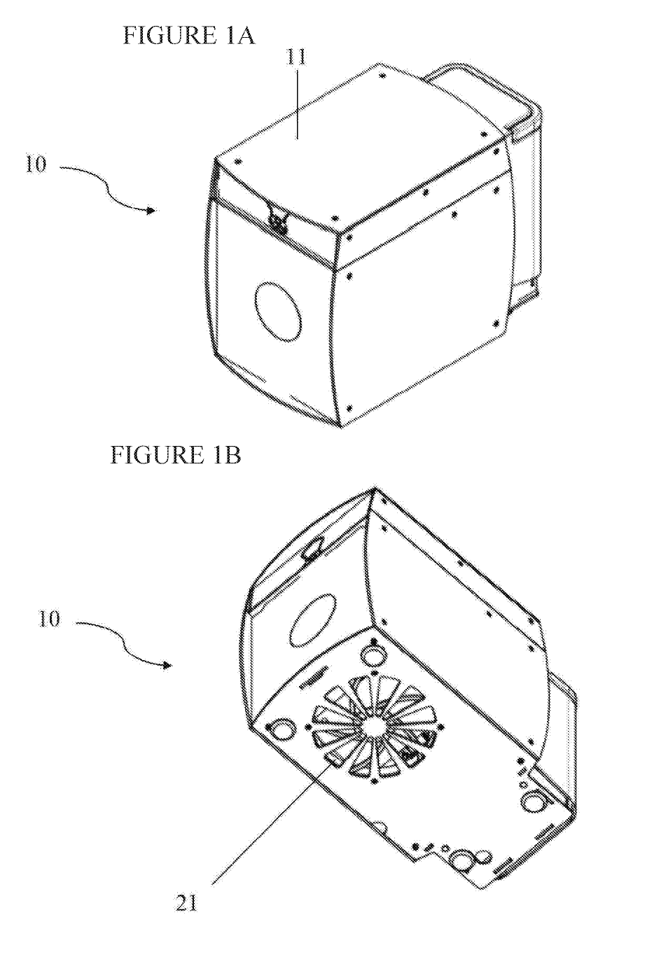

Embodiments of a typical device for use with the method of cooking as described herein are provided in FIGS. 1A to 3B and 13. FIGS. 1A and 1B provide, respectively, a top view and a bottom view of a cooking device 10 with the lid 11 closed. A cooling or venting fan 21 may be provided to remove excess heat from the cooking device. For example, a device may have a fan for venting steam out of the cooking device (such as out the top). A device may also have a base fan which is used to cool the internal temperature of the cooking device and, thus, may also serve to reduce the internal pod temperature.

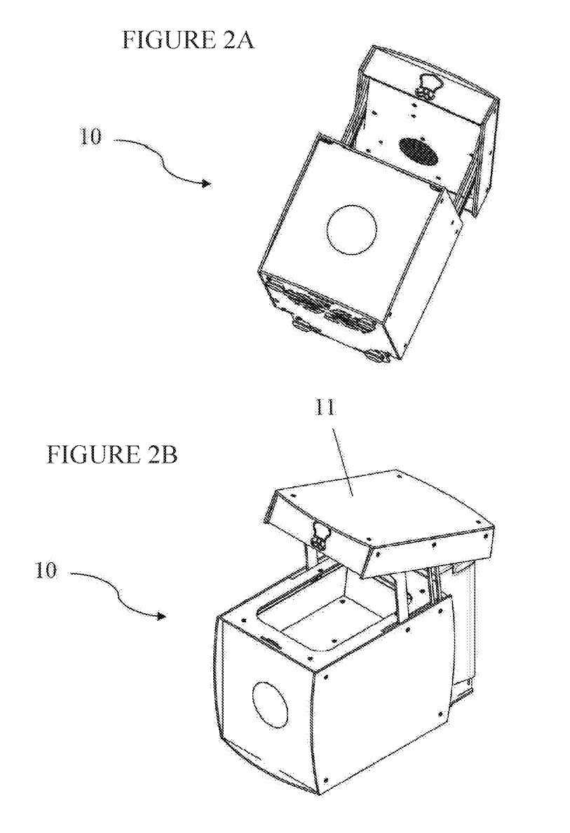

FIGS. 2A and 2B illustrate, respectively, a front view (top) and an upper side view (bottom) of one embodiment of the cooking device 10 with the lid 11 opened. The lid 11 can be opened to permit entry of the pod containing the ingredients to be cooked. The lid 11 is typically hinged to permit easy opening and closure. The opening and closing of the lid 11 may be performed manually or with electronic means.

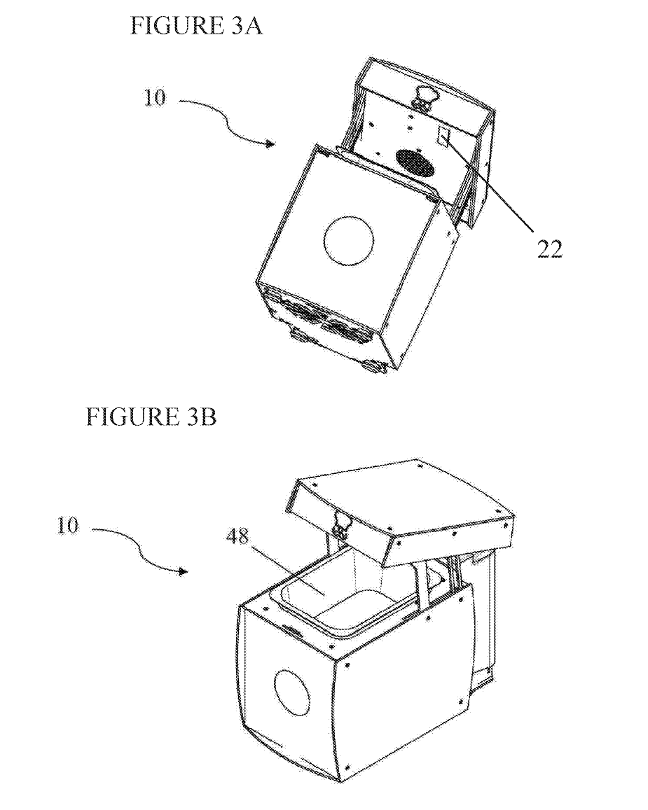

FIGS. 3A and 3B illustrate, respectively, a front view (top) and an upper side view (bottom) of the device 10 with the lid 11 opened and containing an empty pod 48 therein. In typical embodiments, a pod is placed in direct contact with, or as close as possible contact with, a heating element inside the cooking device for cooking. Ideally, the pod should be in as close contact to the heating element as possible to reduce energy loss or any dampening effect of heat control provided by the device. FIG. 4 illustrates one exemplary empty pod 48 in isolation.

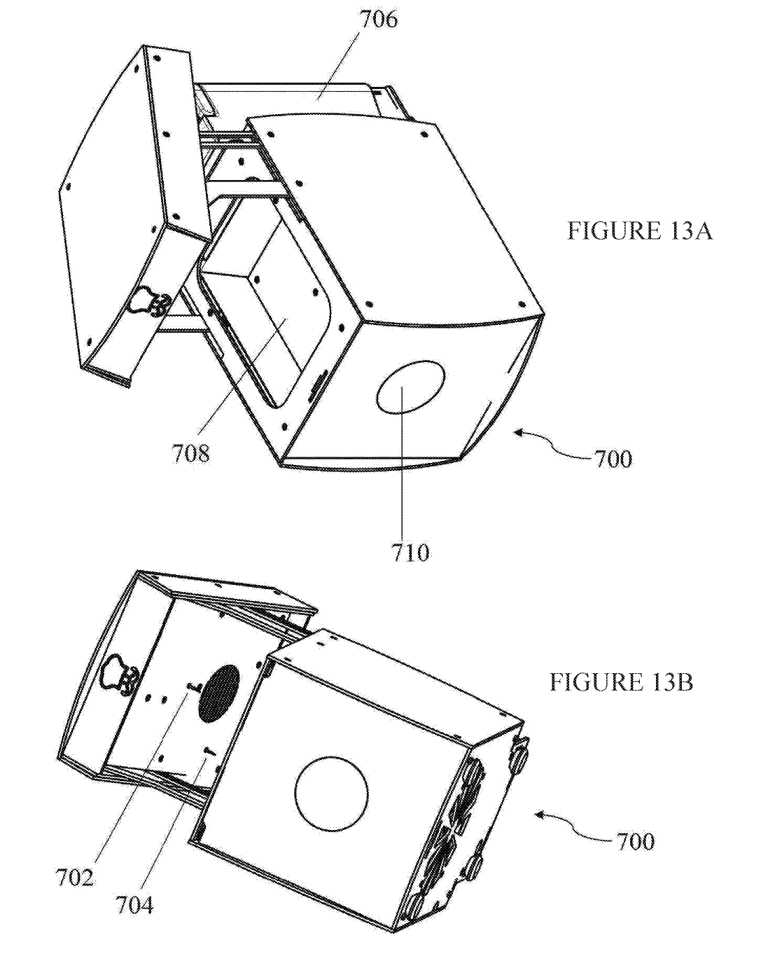

FIGS. 13A and B show different views of another embodiment of an exemplary cooking device 700 with the lid opened. FIG. 13A shows an upper view, while FIG. 13B shows a lower view. The underside of the lid in this embodiment comprises two members thereon, as best shown in FIG. 13B, although any number of members may be provided. In this embodiment, the members are a water injector 702 and a sensor 704.

The water injector 702 is a water dispensing means that injects water from the water reservoir 706 to the pod while cooking. Thus, the water injector 702 is in fluid communication with the water reservoir 706 to provide water through the water injector 702 to the pod. The water injector 702 typically comprises a sharp tip, or may be a needle, suitable for puncturing a hole through the covering member on the pod. Via the water injector 702, water is added to the pod, based on the thermal function associated with the particular pod used, adding an amount of water, and at a frequency and duration, as required by the thermal function. FIG. 5 illustrates a side view of one embodiment of the cooking device 10 showing an exemplary water reservoir 62 and a water pump 61 to provide water to the pod via a water tube 60. Water may also be provided from a fixed source, such as a tap. The water level in the pod may be measured using a water level sensor (such as a sensor as described below) and water may be added to the pod as required during the cooking process by injecting water into the pod from the water reservoir to and through the water injector.

In one embodiment, the various electronic components of the cooking device, including for example, the sensor, the water injector, the water pump and/or the water reservoir, are all connected to a central processor. The central processor may then relay instructions from one component to another to control the heat or humidity. For example, the sensor may detect that heat needs to be added to the pod, and will relay information to the central processor. In other embodiments, the various electronic components may be in direct communication with each other. Ideally, the central processor can be used to coordinate the signalling between the electronic components to ensure a proper cooking process.

Water added to the pod, typically through the water injector at the top of the pod for example, may contact the food inside the pod directly, and/or may pass through any of the holes in the floor of the pod, to arrive in the elevated base layer. The water added thereto, thus, may be heated by the heating element to produce steam. This steam may then travel back through the holes in the pod floor to cook with food in the compartment(s) of the pod.

The sensor 704 also may comprise a sharp tip or the like, which is suitable for puncturing a hole through the covering member on the pod. The sensor 704 is ideally used to measure one or more “cooking variables”, such as the amount of heat and/or humidity inside the pod, among others, for example. An individual sensor 704 may function to measure one or more cooking variables (e.g. temperature and humidity, etc.), or, in other embodiments, there may be more than one sensor provided in the cooking device, where each sensor measures a particular cooking variable. Based on the information collected from the sensor(s), and the associated thermal function for the particular pod used, heat and/or water may be added to the pod. Each sensor (i.e. a single sensor for monitoring one or more cooking variable, or a plurality of sensors each monitoring a cooking variable), is typically in communication with one or more, typically two or more, functional components in the cooking device, to control, for example, heat and/or humidity. As stated above, the various electronic components of the cooking device (including the sensor) may be in direct communication with each other. Ideally, however, the central processor is used to coordinate the signalling between the electronic components to ensure a proper cooking process. For example, a functional component may correspond to a particular cooking variable—as one example, a heating element 708 is a functional component that corresponds to the cooking variable of temperature. In certain embodiments, for example, a single sensor may be in communication (directly or indirectly) with both the water injector (which may communicate with the water reservoir, or the sensor may in communication with the water reservoir/pump directly), and/or in communication with the heating element. In typical embodiments, however, these various components are all connected to the central processor to coordinate any modifications to the desired functional component and associated cooking variable. For example, if the temperature detected by the sensor 704 in the pod is lower than is required by the associated thermal function, the heating element 708 in the cooking device will be activated, thereby providing more heat to cook the contents of the pod, for a period of time as required. If the temperature in the pod is too high based on the thermal function, the heating element 708 may be deactivated for a period of time, or in certain embodiments, a cooling fan may also be provided with the device, such that the cooling fan is activated to cool down the cooking device and facilitate the reduction in temperature in the pod. Further, if the level of humidity in the pod is too low, water may be dispensed through the water injector 702. The sensor 704 may monitor the temperature repeatedly, typically every 1 second, every 2 seconds, or any other period of time. In one embodiment, the sensor monitors the temperature on a variable basis.

A barcode reader 22 is best illustrated for example in FIG. 3A (top). In this embodiment, the barcode reader is situated behind a protective transparent member, such as glass. Any suitable barcode reader may be used.

The cooking device 10 may comprise a user interface with one or more buttons 710 for activation by the user to start cooking the meal in the pod.

Optionally, there may be a speaker announcing when the meal is complete. A Wifi chip and microcontroller may be provided. The cooking device may also include a safety system control to remove safety hazards. For example, this may be used to monitor if the temperature of the device, or the internal pod temperature, is too hot such that a safety hazard would be produced.

Cooking Method

In typical embodiments, a pod has a thermal function associated with the contents of the pod. However, the cooking time may be adjusted by user. Typically, a cooking method includes an average power (e.g., in watts), an initial water amount to be added to the pod (e.g. in mL), and an amount of water that can be added, as required (e.g. mL/minute). Typically, a particular recipe is associated with one pod. However, it may be possible that one pod may be used for different recipes. The design of a pod can be used for different recipes depending on what ingredients are placed in the sub-compartments of the pod.

Thermal Function

Typically, the cooking device as described herein has a means to detect the internal temperature of the pod. Means can include a pod internal temperature sensor as described above. To ensure proper cooking, the present cooking device employs a thermal function. The thermal function takes into account a number of cooking variables (e.g. the initial temperature of the pod as measured by the pod internal temperature sensor, the temperature required for effectively cooking the particular contents of the pod, the level of humidity inside the pod, etc.). The thermal function can be used to adjust the temperature required to cook the ingredients of the pod, depending on factors which can affect the cooking. These can include, for example, the initial temperature of the pod, and any adjustments necessary to calibrate the temperature provided by the device to the pod. In certain embodiments, the thermal function may take into account the contact the pod has with a cooking surface (e.g. a heating element in the cooking device), based on the temperature measured by the sensor. The device may adjust the temperature inside the pod by increasing the temperature, for example, as may be required in accordance with the specifications of the desired recipe. By increasing the temperature, the sensor would signal the heating element to activate. With the activation of the heating element, an amount of steam from any water present in the elevated base layer may be generated, and allowed to pass through the one or more openings in the floor of the pod compartment(s) to be in contact with the food inside the pod.

Using the Pod

All ingredients for the particular recipe (and its associated thermal function), are pre-packaged inside assigned compartments of that pod. This can also include a sauce, spice or other components which complements the main ingredients of the meal to be prepared. For a given recipe, the amount of ingredient inside the pod is controlled and weights are within acceptable range based on the volume limits of the pod sub-compartments. This is particularly advantageous to the consumer, who would not have to worry about obtaining the right amount of raw ingredients for a particular recipe, nor seek out a recipe that could be used for the ingredients already provided. The user simply selects a desired pod and places the pod into the cooking device. The contents of the pod are particularly pre-selected to provide a complete meal, although many different pods and ingredients could be provided and available to the user.

Each ingredient may be assigned a particular value corresponding to the level of preparedness—a “doneness” function. Cooking is typically achieved based on the contents of the sub-compartments and the effects of the thermodynamics of the pod, and the location of the openings/holes in the floor of the pod, i.e., beneath one or more compartments in the pod. For example, an ingredient in a compartment having holes underneath would typically allow more steam to rise through the holes to the food, thereby cooking faster than an ingredient not contained directly above any holes in the floor of the pod. The holes can act as a drain to the bottom (i.e. to the elevated base layer), thus certain ingredients may or may not sit in their own juices during the cooking process which may retain more heat over time during dry cooking.

Each recipe, as provided by the cooking device, comprises one or more steps, ordered sequentially. Each step of the recipe has a particular element of the cooking method for the pod. For example, each step may have a particular target temperature that is required to achieve “doneness”.

As stated above, the cooking device typically comprises a computer component having a processor comprising instructions thereon for executing one or more steps in the operation of the device described herein (such as heating or adding water, for example, based on what the sensor(s) detect(s)). The computer may be coupled with one or more other devices, such as a video display, or another device having a video display thereon. Information, such as memory media, may be obtained from a storage device or obtained remotely such as through the internet, or connected via WiFi to a remote computer through any suitable network, such as a local area network or a cellular network, for example. Recipes may be stored in a processor on board the cooking machine. In other embodiments, recipes can be obtained by a remote database.

For ideal cooking of the ingredients in the pod using the desired recipe, consistent direct or close contact of the heating element 708 and pod is desirable. Typically, as a user closes the lid, the lid locks into place, thereby pressing the pod into proximity with the heating element 708. A heating coil 63 may be present to heat the heating element 708, although other ways of heating may be provided. The sensor 704 may also be used to measure the contact cooking surface of the pod and adjust the temperature in accordance with the thermal function, as described above. On closure of the lid, the sensor and/or water injector typically puncture the lid covering the top of the pod. This permits entry of the sensor (or more than one sensor, if provided) and the water injector into a compartment of the pod to detect temperature and/or humidity on the inside of the pod.

To gain a better understanding of the invention described herein, the following examples are set forth. It should be understood that these examples are for illustrative purposes only. Therefore, they should not limit the scope of this invention in any way.

### Example 1: Cooking Process

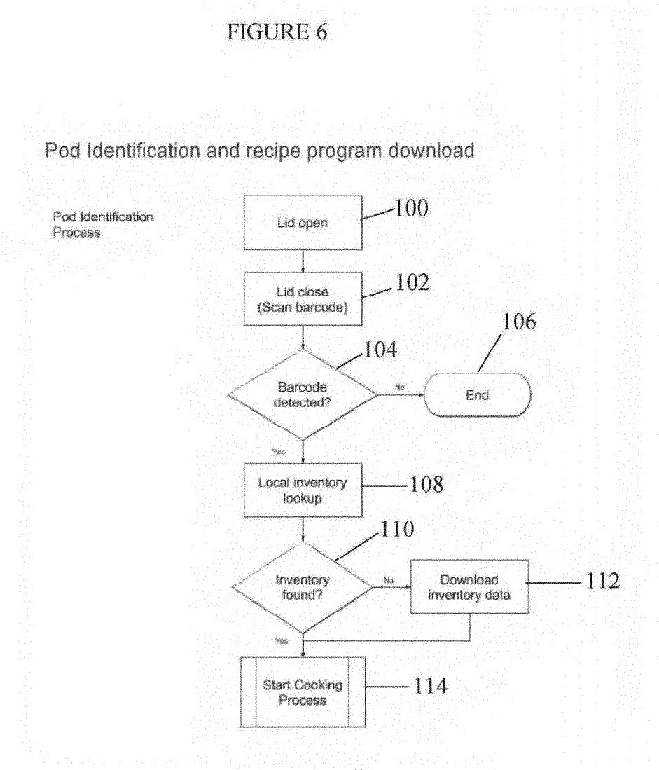

FIG. 6 provides a flowchart illustrating an exemplary method of pod identification and recipe program downloading.

In use, the lid on the cooking device (such as, for example, the lid 11 on the cooking device 10, in one embodiment) is opened 100, and a pod is inserted into the device. The lid is closed and the device scans to see if a barcode is detected 102. If a barcode is detected 104, the local inventory is reviewed 108. The barcode of the pod may identify details of the pod including the type of pod and the associated thermal function, for example. If no barcode is detected, the process ends 106. However, if inventory is found locally which corresponds to the barcode 110, the cooking process is started. If inventory is not found, information may be downloaded 112 from a remote database, such as through the internet, for example. The cooking device can then start the cooking process 114.

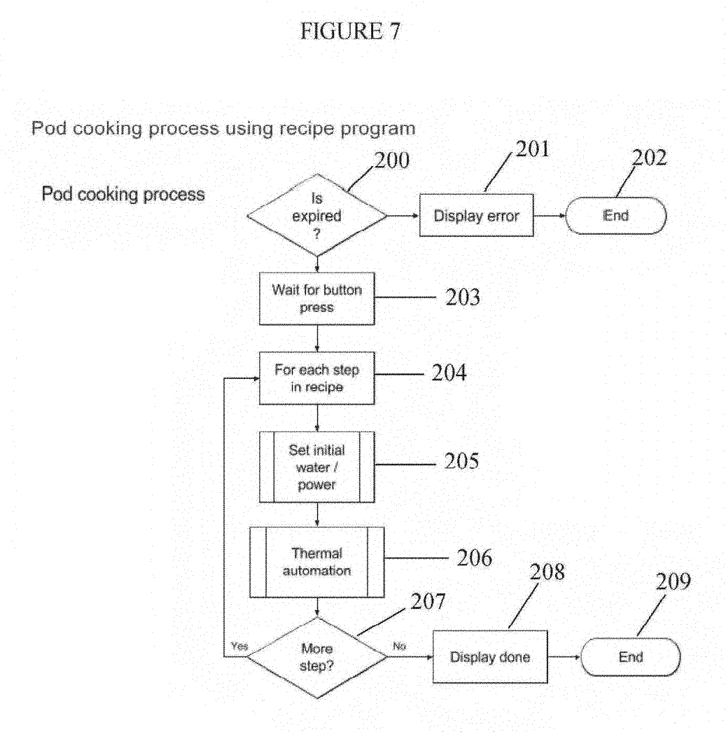

FIG. 7 illustrates an exemplary cooking process flowchart using a recipe program. The device determines if the product in the pod is expired 200 (e.g., where the product in the pod is beyond an expiration or “best before” date). If it has expired, a display error 201 is shown on the screen and the process ends 202. If not, the cooking device waits for the user to activate the device by pressing a button 203. The device starts the cooking process by following the steps sequentially. For each step in the recipe 204, the device sets the initial water and power (e.g. heat) 205 and adjusts each as required using thermal automation 206. The device then determines if an additional step is required 207; if yes, the step is repeated 204. If an additional step is required the process returns to step 204 and begins the process again of determining the water/power 205 and thermal automation 206. If no further steps are required, the display indicates that the cooking is complete 208 and the process ends 209.

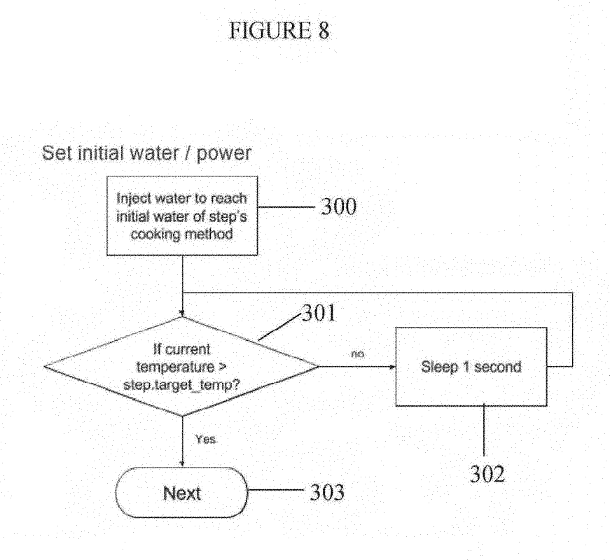

FIG. 8 illustrates an exemplary method of setting the initial water/power. An initial amount of water to reach the amount required for the cooking method is injected into the pod 300. The current temperature of the pod is determined 301. If the current temperature is greater than the target temperature the process proceeds to the thermal automation process 303. If not, the device sleeps for, for example, 1 second 302 and the temperature is taken again 301. An amount of water injected into the pod may then travel through a compartment in the pod, pass through any of the holes on the floor of the pod, and arrive in the elevated base layer, which may be used as steam for steaming the food in the pod, on activation of the heating element.

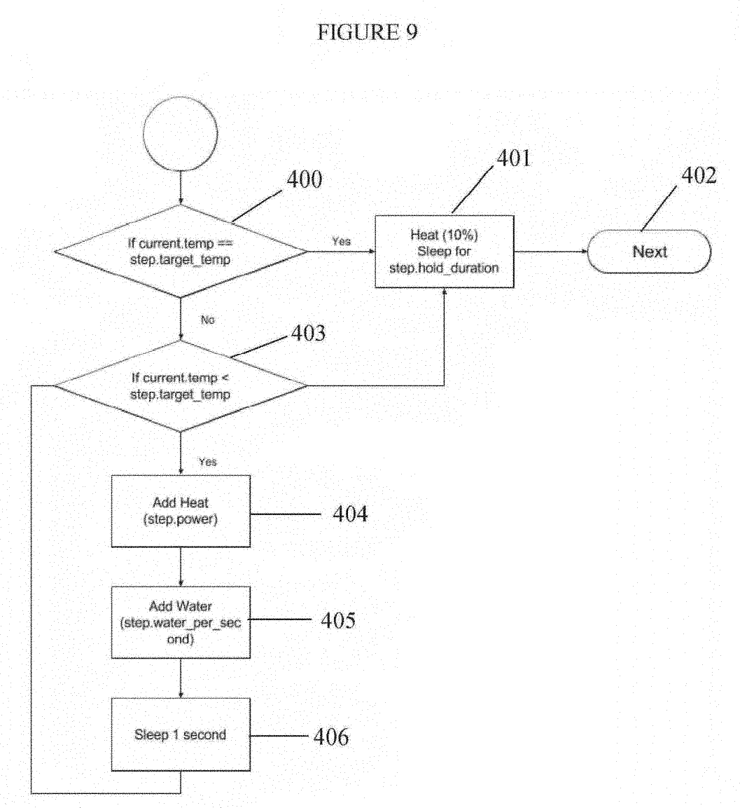

FIG. 9 provides a flowchart illustrating an exemplary thermal automation process. The device can be used to adjust the power level to “average power” of the cooking method. In certain embodiments, the temperature in the pod is measured by the sensor 704. The temperature in the pod should correspond to the temperature required by the recipe. For example, if adjustments need to be made to the temperature (e.g., turn up the heat) based on the measurements as determined by the sensor(s), then the device will automatically turn up the heat. In another example, if the humidity level of the pod is lower than required as detected by the sensor(s), an amount of water may be added to the pod via the water injector 702. Thus, the sensor 704 may send instructions to the water pump/water reservoir, such as through the processor, and/or the heating element, to adjust the water or heat in the pod, respectively. The thermal function may be used to calculate the duration to reach the target temperature. The target temperature is determined by the recipe. In some embodiments, the duration of cooking will be varied depending on calibration during actual cooking. The device determines the current temperature 400. If it is equal to the target temperature, heat is kept controlled 401. For example, the heat may be turned to a self-calibrated percentage (such as 10%) for keeping the temperature at the desired point. In one embodiment, the temperature sensor may be used to calibrate the temperature (using a control algorithm, for example) to determine the correct heat to apply. If a lower temperature is required, the heat may be turned off at the heating element, allowing the pod temperature to go down. In some embodiments, a cooling fan may be used to accelerate the cooling by applying forced air in the system. Cooking continues. However, if the current temperature is less than the target temperature, heat is added 404 and water is added 405; the device then sleeps for 1 second 406 and the temperature is determined again 403. Thus, the thermal function for cooking a particular meal provides that the one or more cooking variables (such as temperature and/or humidity inside the pod) are monitored over time and are properly controlled, thus ideally providing a cooked meal in accordance with the recipe for the particular pod.

Once the thermal function duration is completed the machine starts the next step (e.g., determining if the pod is at the correct temperature, determining the remaining duration of the cooking process, etc.); if there are no more steps, the cooking is completed. The user can then remove the pod from the machine and open the top seal to enjoy the contents of the meal. Optionally, a user can add one or more sauce packs into the full meal. In certain embodiments, sauce packs are provided in separate bags, inside the pod compartments. In certain embodiments, some sauces are designed to self release due to temperature increases inside the pod.

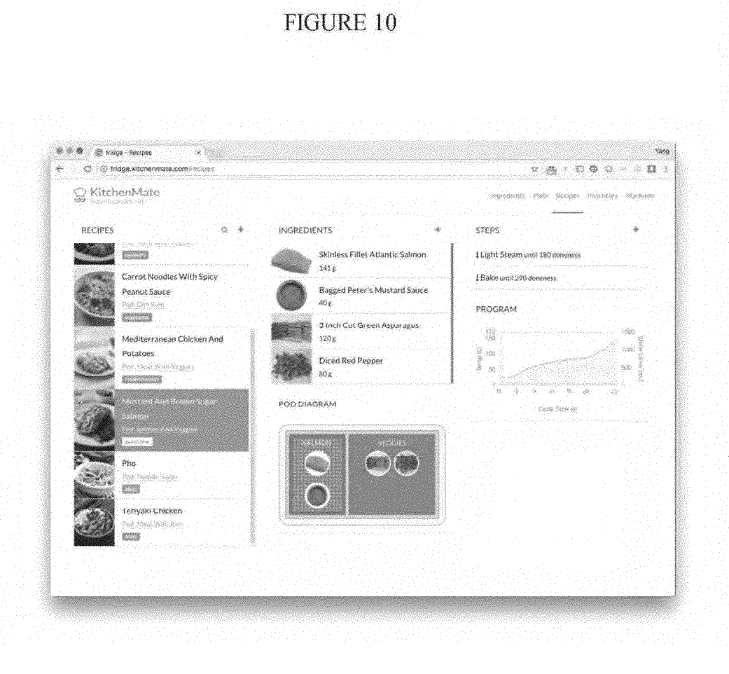

FIG. 10 provides an exemplary user interface for selecting recipes. In certain embodiments, a user can select a recipe remotely and send the recipe and instructions to the device using a smartphone (such as through an app), computer or other remote device connected wired or wirelessly to the cooking device.

All publications, patents and patent applications mentioned in this Specification are indicative of the level of skill of those skilled in the art to which this invention pertains and are herein incorporated by reference to the same extent as if each individual publication, patent, or patent applications was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

The embodiments of the invention in which an exclusive property or privilege is claimed are defined as follows:

1. An automatic cooking device for cooking one or more pre-packaged ingredients in a cooking pod, the device comprising:
a device body;
a heating element for receiving and heating the cooking pod;
a barcode reader for reading a barcode or other indicia on the cooking pod;
one or more sensors for measuring one or more cooking variables in the cooking pod;
a water dispensing means to dispense a quantity of water to the inside of the pod; and
a computer processor.

2. The cooking device of claim 1, wherein the one or more cooking variables comprises one or more of temperature, humidity, duration of cooking, and the like.

3. The cooking device of claim 1, wherein the one or more sensors measure the temperature and/or humidity on the inside of the pod, and wherein the one or more sensors is/are in communication with the heating element and/or the water dispensing means.

4. The cooking device of claim 3, wherein the one or more sensors is/are in communication with the computer processor.

5. The device of claim 1, wherein the barcode identifies a thermal function associated with cooking the ingredients in the pod.

6. The device of claim 5, wherein the thermal function comprises a set of instructions for adjusting the one or more cooking variables associated with cooking the contents of the pod.

7. The device of claim 6, wherein: the processor comprises computer readable memory comprising instructions for executing the thermal function; or the processor obtains instructions for executing the thermal function remotely, including from a remote database obtained through a network including Wifi.

8. The cooking device of claim 1, wherein the one or more sensors determines a temperature inside the pod and adjusts the temperature of the pod as required by modulating the heating element.

9. The device of claim 1, wherein the water is stored in a reservoir on board the device body.

10. The device of claim 1, wherein the one or more sensors and/or the water dispensing means create an opening in a pod seal to permit water to enter the pod and/or to facilitate sensing of the temperature and/or humidity on the inside of the pod by the one or more sensors, and/or to release excessive steam or pressure from the pod.

11. The device of claim 1, wherein the pod comprises one or more compartments comprising one or more ingredients therein.

12. The device of claim 1, wherein the pod comprises an elevated base layer disposed between a floor of the pod in contact with the ingredients therein, and a bottom surface of the pod in contact with the heating element.

13. The device of claim 12, wherein the floor of the pod comprises one or more openings therethrough to provide communication between at least a portion of the interior of the pod and the elevated base layer.

14. The device of claim 13, further comprising one of the following characteristics wherein: the openings permit the passage of fluids from the interior of the pod through the openings and into the elevated base layer; the openings permit the passage of water and/or steam therethrough; and the openings permit the passage of steam from the elevated base layer to the interior of the pod.

15. A method of cooking a quantity of food pre-packaged in a cooking pod, the method comprising:
a. introducing the pod into a cooking device having a barcode reader for reading a barcode or other indicia on a surface of the pod;
b. determining a recipe corresponding to information obtained from reading the barcode;
c. determining the temperature inside the pod and, if the temperature is different from the temperature required by the recipe, adjusting the temperature to a target temperature in accordance with a thermal function associated with the recipe, using a heating element in the cooking device;
d. determining humidity inside the pod corresponding with the recipe and, if required, adding water to the pod;
e. if necessary, repeating steps c. to d. to ensure a proper temperature and humidity are provided inside the pod in accordance with the recipe;
f. heating the pod for a desired length of time at the target temperature until the contents of the pod are cooked in accordance with the recipe;
g. removing the pod from the device at the termination of cooking, for consumption of the contents of the pod.

16. The method of claim 15, wherein the pod is placed in contact with the heating element in the cooking device.

17. The method of claim 15, wherein during the step of determining the temperature of the pod, the heat is adjusted to a target temperature based on the thermal function and, if necessary, a calibration variable further adjusts the temperature based on the contact efficiency between the pod and the heating element.

18. The method of claim 15, wherein the step of determining the temperature and the step of determining the humidity inside the pod is determined by one or more sensors.

19. The method of claim 18, wherein: the one or more sensors are positioned on a surface of the lid of the cooking device which is in contact with the pod, such that when the lid is closed with the pod in the cooking device, the one or more sensors punctures an opening in a covering on the pod, thereby providing access of the sensor(s) to an interior of the pod; or the one or more sensors are in communication with the heating element and/or a water dispensing reservoir directly or through a processor in the cooking device.

20. The method of claim 15, wherein the step of adding water to the pod is performed by a water dispensing means.

21. The method of claim 20, wherein the water dispensing means is positioned on a surface of the lid of the cooking device, wherein when the lid is closed, the water dispensing means punctures an opening in a covering on the pod, such that the water dispensing means has access to provide water to the interior of the pod.

22. The method of claim 21, wherein the water dispensing means is in fluid communication with a water dispensing reservoir.

23. The method of claim 15, wherein the step of determining the temperature and/or humidity is performed on a regular interval, such as every 1 second.

24. The method of claim 15, wherein the pod comprises an elevated base layer disposed between a floor of the pod in contact with the ingredients therein, and a bottom surface of the pod in contact with the heating element.

25. The method of claim 24, wherein the floor of the pod comprises one or more openings therethrough to provide communication between at least a portion of the interior of the pod and the elevated base layer.

26. The method of claim 25 wherein: the openings permit the passage of fluids from the ingredients through the openings in the floor and into the elevated base layer; or the openings permit the passage of water and/or steam therethrough.

27. The method of claim 25, wherein in the step of adjusting the temperature, when the temperature is increased, the heating element is activated to increase the temperature inside the pod, thus forming a quantity of steam from a least a portion of any water in the elevated base layer, whereby the steam is permitted to pass through the openings from the elevated base layer to the interior of the pod.
